(19) United States
(12) Patent Application Publication
(10) Pub. No.: US 2023/0267058 A1
(43) Pub. Date: Aug. 24, 2023

(54) COMPUTER-READABLE RECORDING MEDIUM STORING MANAGEMENT PROGRAM, MANAGEMENT METHOD, AND DATA COLLECTION DEVICE

(71) Applicant: Fujitsu Limited, Kawasaki-shi (JP)

(72) Inventor: Mari YAMAOKA, Minato (JP)

(73) Assignee: Fujitsu Limited, Kawasaki-shi (JP)

(21) Appl. No.: 17/984,284

(22) Filed: Nov. 10, 2022

(30) Foreign Application Priority Data
Feb. 18, 2022 (JP) 2022-024328

(51) Int. Cl. G06F 11/34; G06F 9/50

(52) U.S. Cl. CPC G06F 11/3409; G06F 9/5016; G06F 2209/501; G06F 2209/508

(57) ABSTRACT

A non-transitory computer-readable recording medium stores a management program for causing a computer to execute processing including: acquiring information regarding a usage status of a first memory for data transfer included in a measurement target from each of a plurality of the measurement targets; calculating priority of data transfer of each of the plurality of measurement targets, based on the acquired information regarding the usage status of the first memory; collecting measurement data from the first memory of any one of the plurality of measurement targets, based on the calculated priority; and storing the collected measurement data in a second memory that stores measurement data output to a data processing unit that processes the measurement data of each of the plurality of measurement targets.

### CROSS-REFERENCE TO RELATED APPLICATION

This application is based upon and claims the benefit of priority of the prior Japanese Patent Application No. 2022-24328, filed on Feb. 18, 2022, the entire contents of which are incorporated herein by reference.

### FIELD

The embodiment discussed herein is related to a management program, a management method, and a data collection device.

### BACKGROUND

Typically, a performance of a measurement target is investigated. For example, a cause of performance deterioration may be performance-investigated using a tool for performance analysis. The measurement target is, for example, a computer device (machine) such as a personal computer (PC), a central processing unit (CPU), a memory, or the like. For example, in memory performance investigation, a counter value indicating a resource usage status is acquired as measurement data, and a measurement result such as a memory usage rate or a free memory capacity is calculated by executing arithmetic processing on the counter value. For the measurement target performance investigation, there is a system that targets a plurality of measurement targets and transfers and stores measurement data from the plurality of measurement targets to and in a database (DB) on a single management server. In this system, the management server may collect the measurement data from the plurality of measurement targets through Pull-type data transfer.

Japanese Laid-open Patent Publication No. 2021-105897 and U.S. Pat. Application Publication No. 2011/0320744 are disclosed as related art.

### SUMMARY

According to an aspect of the embodiments, a non-transitory computer-readable recording medium stores a management program for causing a computer to execute processing including: acquiring information regarding a usage status of a first memory for data transfer included in a measurement target from each of a plurality of the measurement targets; calculating priority of data transfer of each of the plurality of measurement targets, based on the acquired information regarding the usage status of the first memory; collecting measurement data from the first memory of any one of the plurality of measurement targets, based on the calculated priority; and storing the collected measurement data in a second memory that stores measurement data output to a data processing unit that processes the measurement data of each of the plurality of measurement targets.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of a management method according to an embodiment;

FIG. 2 is a block diagram illustrating a hardware configuration example of a data collection device 100;

FIG. 3 is a block diagram illustrating a functional configuration example of the data collection device 100;

FIG. 4 is an explanatory diagram illustrating a data transfer example of measurement data by the data collection device 100;

FIG. 5 is a flowchart illustrating an example of a processing procedure of a measurement target 110;

FIG. 6 is a flowchart illustrating an example of a processing procedure of a priority calculation unit 102;

FIG. 7A is a flowchart illustrating an example of a processing procedure of a collection control unit 101 (part 1);

FIG. 7B is a flowchart illustrating an example of the processing procedure of the collection control unit 101 (part 2);

FIG. 8 is a flowchart illustrating an example of a processing procedure of a management server 120;

FIG. 9 is a timing chart of a specific example of Pull control based on priority calculation performed by the data collection device 100;

FIG. 10 is an explanatory diagram of a transfer state of measurement data according to related art;

FIG. 11 is an explanatory diagram of a memory usage rate of a measurement target according to the related art; and

FIGS. 12A and 12B are explanatory diagrams illustrating a relationship between a frequency of transfer waiting and performance investigation accuracy according to the related art.

### DESCRIPTION OF EMBODIMENTS

For example, there is related art in which a management server divides a log of a work server for each fixed capacity and stores the log in a storage unit and a log collection timing is controlled according to a storage capacity of the storage unit. Furthermore, there is related art that captures data and transfers data to a data collection station in consideration of priority at a collection point such as an input/output (I/O) interface in a multiprocessor system, temporarily saves the data in a buffer of the data collection station, and moves the data to a target saving position.

However, in the related art, for example, in a case where the number of measurement targets is multiple, measurement data transfer waiting from a plurality of measurement targets may occur. When a capacity of a buffer is consumed in the measurement target of which the measurement data is waiting for being transferred, measurement (profiling) of the measurement data stops, and missing measurement data is generated for a stopping period, and accuracy of performance investigation by a management server deteriorates.

In one aspect, an object of the embodiment is to present overflow of a memory of each of a plurality of measurement targets.

Hereinafter, an embodiment of a management program, a management method, and a data collection device according to the present disclosure will be described in detail with reference to the drawings.

### Example of Management Method According to Embodiment

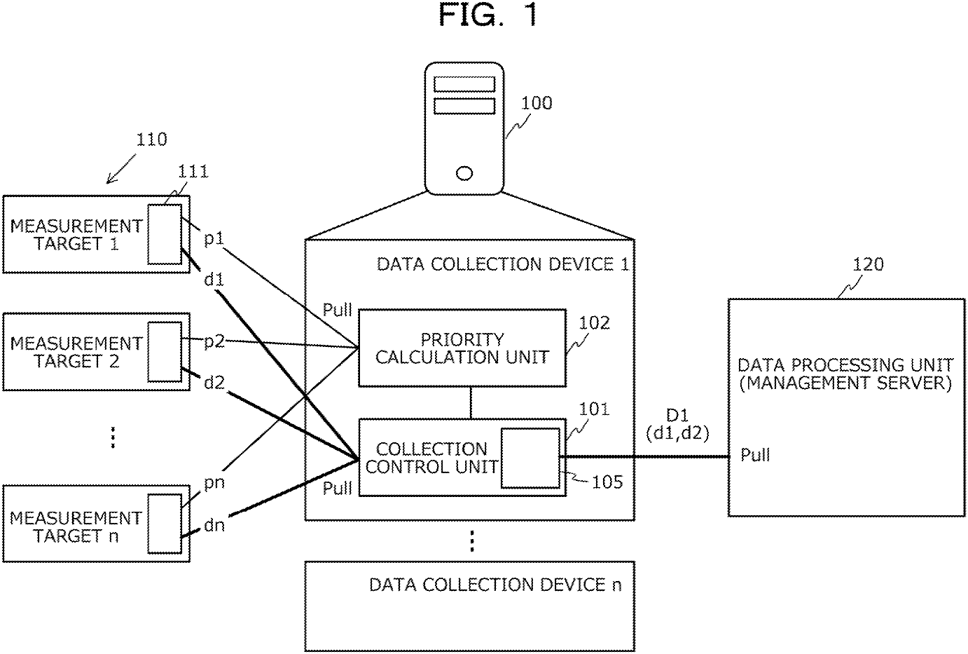

FIG. 1 is an explanatory diagram illustrating an example of a management method according to an embodiment. A data collection device 100 according to the embodiment is a computer that transfers data D, which is a collection of measurement data d collected from a plurality of measurement targets 110, to a data processing unit 120. In the following description, the data processing unit 120 will be described using a management server outside the data collection device 100 as an example.

The data collection device 100 is, for example, a server, a personal computer (PC), or the like. For example, the management method according to the embodiment is applied to a system that transfers measurement data measured by each of the plurality of measurement targets 110 to the management server 120 and investigates a performance of the measurement target 110 based on the measurement data by the management server 120. The measurement target 110 includes a memory for data transfer (first memory, sampling data buffer) 111, and the data collection device 100 includes a memory for data transfer (second memory, data buffer) 105.

The measurement target 110 is, for example, a machine such as a PC or a CPU, a memory, or the like in the machine (PC), and the management server 120 investigates a performance of each measurement target 110, based on the measurement data transferred from the measurement target 110.

Typically, transfer waiting of the measurement data may occur between the measurement target 110 and the management server 120. For example, in a case where the number n of the measurement targets 110 is larger than the number of simultaneously possible communications between the measurement target 110 and the management server 120 (1: n), transfer waiting of measurement data of one measurement target 110 may occur due to a communication traffic between the measurement target 110 and the management server 120.

The measurement target 110, in which the transfer waiting occurs, restarts measurement while holding measurement data, of which communication is attempted and which waits or has been measured and has not been transferred yet, in the memory 111. However, in a case where a measurement frequency is higher than a data transfer frequency in the measurement target 110 in which the transfer waiting occurs, a usage rate of the memory 111 may increase, and a memory capacity may be consumed. When the memory capacity is consumed, measurement (profiling) of the measurement data in the measurement target 110 stops. In this case, the measurement data of the measurement target 110 is lost in the management server 120, and accuracy of the performance investigation of the measurement target 110 is lowered.

Therefore, in the present embodiment, the data collection device 100 is arranged between the plurality of measurement targets 110 and the management server 120. A management method performed by the data collection device 100 will be described with reference to FIG. 1. The data collection device 100 includes a collection control unit 101 and a priority calculation unit 102. The collection control unit 101 collects measurement data d from the plurality of measurement targets (1 to n) 110 and transfers the measurement data d to the management server 120. The priority calculation unit 102 calculates priority indicating a measurement target 110 from among the plurality of measurement targets (1 to n) 110 of which a collection of the measurement data d is prioritized, regarding the measurement data d collected by the collection control unit 101.

(1) The measurement target 110 stores, for example, the measurement data d measured at each predetermined interval in the memory 111. For example, when the number of pieces of the measurement data d for multiple times stored in the memory 111 reaches a predetermined number, the measurement target 110 sets a Pullable flag (for example, set value “1”). The flag is set in correspondence with a data capacity that can be stored in the memory 111. The measurement target 110 deletes the measurement data d that has been transferred to the data collection device 100 from the memory 111. Although the description here is omitted, the measurement target 110 stores the measurement data d for multiple times in the memory 111 as a measurement data group.

(2) The data collection device 100 generates measurement data D obtained by grouping the pieces of measurement data d (d1 to dn) measured by the plurality of measurement targets (1 to n) 110 and stores the measurement data D in the memory (data buffer) 105. For example, when the number of pieces of measurement data d for multiple times stored in the memory 111 reaches the predetermined number, the data collection device 100 sets a Pullable flag. The data collection device 100 deletes the measurement data D that has been transferred to the management server 120 from the memory 105.

(3) The management server (data processing unit) 120 acquires the measurement data D through Pull-type data transfer from the memory 105 of the data collection device 100. The management server 120 extracts the data d of the plurality of measurement targets 110 included in the acquired measurement data D and executes processing for investigation a performance of each of the plurality of measurement targets 110 through predetermined arithmetic processing on the data d.

An overview of the processing of the data collection device 100 described in (2) above will be described below.

(2-1) The data collection device 100 collects each piece of the measurement data d (d1 to dn) measured by the plurality of measurement targets (1 to n) 110 by the collection control unit 101. The data collection device 100 collects data through Pull-type data transfer for each measurement target 110. In the Pull type, the data collection device 100 voluntarily performs data transfer and collects data of the measurement data d of the measurement target 110 to which the Pullable flag is set. The Pull type is different from a Push type in which the measurement target 110 voluntarily performs the data transfer. The Pull-type data transfer eliminates need for the measurement target 110 to voluntarily perform transfer control, and a processing cost for the data transfer is reduced.

(2-2) The data collection device 100 calculates priority of the data transfer for each of the plurality of measurement targets (1 to n) 110 by the priority calculation unit 102 and outputs priority information to the collection control unit 101. For example, the priority calculation unit 102 calculates priority based on a tightness degree of data transfer in each measurement target 110. The tightness degree of the data transfer corresponds to, for example, a usage status (for example, memory capacity for untransferred data) of the memory 111 of the measurement target 110. The usage status of the memory can be calculated from a transfer frequency, a measurement frequency, or the like of data in the measurement target 110. The priority calculation unit 102 acquires information p regarding the memory usage status of the memory 111 such as the transfer frequency or the measurement frequency of the data in the measurement target 110 from the measurement target 110 with the Pull type, and calculates the priority for each measurement target 110, based on the acquired information p regarding the memory usage status.

(2-3) The data collection device 100 outputs the priority calculated by the priority calculation unit 102 to the collection control unit 101. The collection control unit 101 of the data collection device 100 collects the measurement data d with the Pull type in order from the measurement target 110 with the highest priority. The collection control unit 101 collects the plurality of pieces of measurement data d, for example, the measurement data d (for example, d1 and d2) of the same or different measurement targets 110 with high priority.

(2-4) The data collection device 100 generates the measurement data D obtained by grouping the measurement data d collected by the collection control unit 101 in predetermined units and stores the measurement data D in the memory (data buffer) 105.

(2-5) The data collection device 100 controls a timing at which the collection control unit 101 acquires the measurement data d from the measurement target 110. The data collection device 100 determines a period (interval) every time before the measurement data d is acquired with the Pull type next, every timing when the measurement data d is acquired with the Pull type at the previous time.

In order to avoid tightness of the memory 111 in the data collection device 100, the collection control unit 101 variably controls an interval cycle according to the number of pieces of measurement data D that has not been transferred to the management server 120. For example, if the number of pieces of measurement data D that has not been transferred to the management server 120 increases, the collection control unit 101 lengthens the interval of Pull of the measurement data d acquired from the measurement target 110. On the other hand, if a large number of pieces of measurement data D can be transferred to the management server 120 (if the number of pieces of untransferred measurement data D is reduced), the collection control unit 101 performs control to shorten the interval of Pull of the measurement data d acquired from the measurement target 110.

The collection control unit 101 varies the Pull type interval for the measurement data d with the measurement target 110. The variable control of the interval performed by the collection control unit 101 has no relation with a timing when the management server 120 acquires the measurement data D from the data collection device 100 with the Pull type. For example, the management server 120 acquires the measurement data D from the memory 105 of the data collection device 100 with the Pull type without performing special control on the tightness degree of the memory 111 of the data collection device 100.

(2-6) The data collection device 100 copes with a case where the data transfer becomes tight in the measurement target 110 after the collection control unit 101 determines the interval once and the measurement target 110 with particularly high priority occurs. The measurement target 110 with particularly high priority is, for example, a measurement target 110 of which priority is equal to or higher than a predetermined threshold that is preset. In this case, the collection control unit 101 executes processing for acquiring measurement data d of the measurement target 110 with particularly high priority with the Pull type, with the highest priority.

In the data collection device 100, a Pull timing of the measurement data d performed by the collection control unit 101 is not synchronized with a Pull timing of the information p regarding the memory usage status performed by the priority calculation unit 102, and each Pull is performed at a different timing. Moreover, the Pull timing of the measurement data D performed by the management server 120 is not synchronized with the Pull timing of the measurement data d performed by the data collection device 100 and the Pull timing of the information p regarding the memory usage status performed by the priority calculation unit 102. For example, the Pull timings of the entire system are independent.

By the way, the Pull timing of the information p regarding the memory usage status performed by the priority calculation unit 102 may be shorter than the Pull timing of the measurement data d performed by the collection control unit 101. As a result, the collection control unit 101 can acquire the information p regarding the memory usage status at high frequency in correspondence with the usage status of the memory 111 of the measurement target 110.

A data transfer example using FIG. 1 will be described. Here, it is assumed that n = 3. The priority calculation unit 102 of the data collection device 1 (100) acquires, with the Pull type, the information p (p1 to p3) regarding the memory usage status such as the transfer frequency or the measurement frequency of the data, regarding the usage status of the memory 111 in the measurement target 110, from the plurality of measurement targets (1 to n) 110. The priority calculation unit 102 calculates priority of data transfer for each of the plurality of measurement targets (1 to n) 110.

Next, the priority calculation unit 102 of the data collection device 1 (100) outputs the calculated priority to the collection control unit 101. The collection control unit 101 collects the measurement data d described in (1) in order from the measurement target 110 with the highest priority with the Pull type. For example, if the order of the priority is a measurement target 1, a measurement target 2, and a measurement target 3, from the highest, the collection control unit 101 of the data collection device 1 (100) collects pieces of measurement data d1, d2, and d3 of the measurement targets 1, 2, and 3 (110) with the Pull type, according to this priority.

Furthermore, for example, if the order of the priority is the measurement target 1, the measurement target 2, and the measurement target 3, from the highest, the collection control unit 101 of the data collection device 1 (100) may collect the measurement data d of some measurement targets 110 of the measurement targets 1, 2, and 3 (110) with the Pull type, according to this priority. Some measurement targets 110 are a predetermined number (less than n) of measurement targets 110, for example, of which the priority is relatively high.

In this way, the data collection device 1 (100) preferentially collects the measurement data d of the measurement target 110 of which data transfer is tight so as to prevent stop of the measurement (profiling) of the measurement data in the measurement target 110 of which the data transfer is tight or the like in advance.

The collection control unit 101 generates the measurement data D obtained by grouping the plurality of pieces of measurement data d, for example, the measurement data d of the same or different measurement targets (1 to n) 110. In the example in FIG. 1, the collection control unit 101 groups the pieces of measurement data d1 and d2 of the measurement targets 1 and 2 with high priority. The management server 120 acquires the measurement data D from the data collection device 1 (100) with the Pull type.

The priority calculation unit 102 calculates priority of the plurality of measurement targets (1 to n) 110 each time when acquiring the information p regarding the memory usage status from the measurement target 110 with the Pull type at a predetermined interval. As a result, the collection control unit 101 constantly acquires the measurement data d in order from the measurement target 110 with the highest priority, based on the latest priority.

Here, the measurement frequency, the data transfer frequency, and a communication traffic status of each of the plurality of measurement targets 110 fluctuate with time, and the tightness degree of the memory 111 of the measurement target 110 fluctuates. In this regard, the data collection device 100 sequentially acquires the information p regarding the memory usage status corresponding to the tightness degree of the memory 111 and dynamically calculates the priority so as to preferentially acquire data from the measurement target 110 of which the memory becomes tight. As a result, the data collection device 100 can efficiently transfer the measurement data d of the plurality of measurement targets 110 to the management server 120.

In this way, in the embodiment, the data collection device 100 is arranged between the plurality of measurement targets 110 and the management server 120, and the data collection device 100 controls the data transfer from the measurement target 110 to the management server 120. As a result, even in a situation where measurement data transfer waiting easily occurs due to the plurality of measurement targets 110, the data collection device 100 arranged between the plurality of measurement targets 110 and the management server 120 can prevent that the memory 111 is consumed and memory overflow occurs. Furthermore, the data collection device 100 efficiently transfers all the pieces of measurement data measured by the plurality of measurement targets 110 to the management server 120 so that the management server 120 can investigate the performance of each measurement target with high accuracy based on the measurement data.

### Configuration Example of Data Collection System

The measurement target 110 and the data collection device 100 configuring a data collection system illustrated in FIG. 1, and the data collection device 100 and the management server 120 are connected via wired or wireless network. The network is, for example, a local area network (LAN), a wide area network (WAN), the Internet, or the like.

As illustrated in FIG. 1, the plurality of (n) data collection devices 100 may be arranged. For example, the data collection device 1 (100) collects measurement data d of measurement targets 1 to n (110) of one group 1, and the data collection device n (100) collects measurement data d of measurement targets 1 to n (110) of another group n.

Furthermore, in the configuration example illustrated in FIG. 1, the data collection device 100 and the management server 120 are illustrated as different devices. However, the data collection device 100 may be arranged as one function in the management server 120.

Furthermore, in FIG. 1, the data collection device 100 includes the collection control unit 101 and the priority calculation unit 102. However, the configuration example is not limited to this. For example, the priority calculation unit 102 may be arranged outside the data collection device 100. In this case, a configuration can be used in which one priority calculation unit 102 can calculate the priority of the plurality of data collection devices 100 (collection control unit 101).

### (Hardware Configuration Example of Data Collection Device 100)

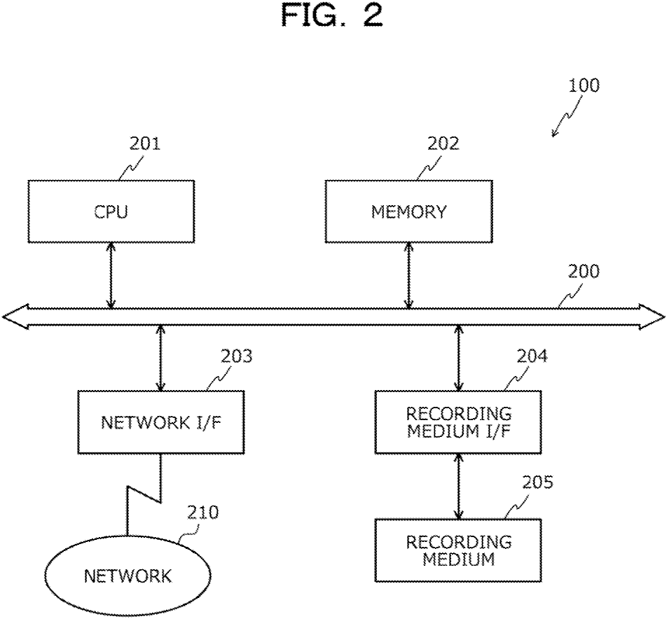

Next, a hardware configuration example of the data collection device 100 will be described with reference to FIG. 2.

FIG. 2 is a block diagram illustrating the hardware configuration example of the data collection device 100. In FIG. 2, the data collection device 100 includes a central processing unit (CPU) 201, a memory 202, a network interface (I/F) 203, a recording medium I/F 204, and a recording medium 205. Furthermore, the components are connected to each other by a bus 200.

Here, the CPU 201 is a control unit that controls the entire data collection device 100. The memory 202 includes, for example, a read only memory (ROM), a random access memory (RAM), a flash ROM, or the like. For example, the flash ROM or the ROM stores various programs, and the RAM is used as a work area for the CPU 201. The programs stored in the memory 202 are loaded into the CPU 201 to cause the CPU 201 to execute coded processing.

The network I/F 203 is connected to a network 210 through a communication line, and is connected to another computer through the network 210. Then, the network I/F 203 manages an interface between the network 210 and the inside, and controls input and output of data to and from the another computer. The network I/F 203 is, for example, a modem, a LAN adapter, or the like.

The recording medium I/F 204 controls reading and writing of data from and to the recording medium 205 under control of the CPU 201. The recording medium I/F 204 is, for example, a disk drive, a solid state drive (SSD), a universal serial bus (USB) port, or the like. The recording medium 205 is a nonvolatile memory that stores data written under control of the recording medium I/F 204. The recording medium 205 is, for example, a disk, a semiconductor memory, a USB memory, or the like. The recording medium 205 may be attachable to and detachable from the data collection device 100.

The data collection device 100 may include, for example, a keyboard, a mouse, a display, a printer, a scanner, a microphone, a speaker, or the like in addition to the components described above. Furthermore, the data collection device 100 may include a plurality of the recording medium I/Fs 204 and a plurality of the recording media 205. Furthermore, the data collection device 100 does not need to include the recording medium I/F 204 and the recording medium 205.

Functions of the collection control unit 101 and the priority calculation unit 102 of the data collection device 100 illustrated in FIG. 1 are implemented by executing a program by the CPU 201 illustrated in FIG. 2. Furthermore, as the memory (data buffer) of the data collection device 100, the memory 202 illustrated in FIG. 2 can be used.

Since the hardware configuration example of the measurement target 110 and the management server 120 is, for example, similar to the hardware configuration example of the data collection device 100 illustrated in FIG. 2, description thereof is omitted. As the memory (sampling data buffer) 111 of the measurement target 110 and the memory (data buffer) 105 of the data collection device 100, the memory 202 illustrated in FIG. 2 can be used.

### (Functional Configuration Example of Data Collection Device 100)

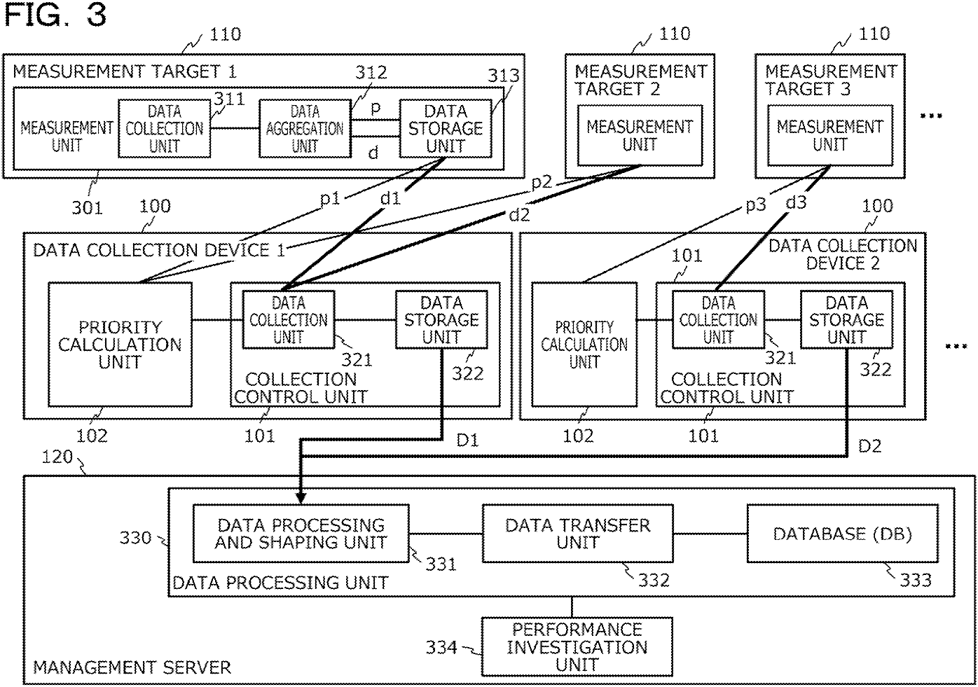

Next, a functional configuration example of the data collection device 100 will be described with reference to FIG. 3.

FIG. 3 is a block diagram illustrating the functional configuration example of the data collection device 100. In FIG. 3, the functions of the measurement target 110 and the management server 120 are illustrated. In FIG. 3, an example is illustrated in which the data collection device 1 (100) collects the measurement data d1 and d2 of the measurement targets 1 and 2 (110) and transmits data D1 obtained by grouping the measurement data d1 and d2 to the management server 120. Furthermore, in FIG. 3, an example is illustrated in which a data collection device 2 (100) collects measurement data d3 and d... of a measurement targets 3 and... (110) and transmits data D2 obtained by grouping the measurement data d3 and d... to the management server 120.

The measurement target 110 is a target such as a machine, a CPU, or a memory of which a performance is investigated by the management server 120. A measurement unit 301 includes a data collection unit 311, a data aggregation unit 312, and a data storage unit 313. For example, the data collection unit 311 collects a state of the measurement target 110 as a counter value for each predetermined sampling cycle, generates measurement data of the measurement target 110 by performing four arithmetic operations on the counter value, and outputs the measurement data to the data aggregation unit 312. For example, in a case where the measurement target 110 is a memory, the data collection unit 311 uses a memory usage rate obtained by performing the four arithmetic operations on a counter value of a memory resource usage status as the measurement data.

The data aggregation unit 312 aggregates a plurality of pieces of measurement data output by the data collection unit 311 for each sampling cycle. The data storage unit 313 is the memory (sampling data buffer) 111 described above and stores the measurement data aggregated by the data aggregation unit 312. The data aggregation unit 312 aggregates measurement data for each predetermined capacity obtained by dividing the maximum capacity, in consideration of the maximum capacity of the memory. For example, the data aggregation unit 312 aggregates a predetermined number of pieces of measurement data corresponding to the predetermined capacity. The data storage unit 313 stores the predetermined number of pieces of aggregated measurement data, for example, in each divided memory obtained by dividing a total memory capacity by a predetermined number.

The data collection device 100 includes a collection control unit 101 and a priority calculation unit 102. The priority calculation unit 102 calculates priority of data transfer of each of the plurality of measurement targets (1 to n) 110 and outputs priority information to the collection control unit 101.

For example, the priority calculation unit 102 calculates the priority based on a tightness degree of data in each measurement target 110. The tightness degree of the data corresponds to, for example, the usage status of the memory 111 in the measurement target 110. The usage status of the memory 111 can be calculated based on the information p regarding the memory usage status such as the transfer frequency or the measurement frequency of the data in the measurement target 110. The priority calculation unit 102 acquires the information p regarding the memory usage status of the memory 111 in the measurement target 110 from the measurement target 110 with the Pull type, calculates the priority based on the acquired information p regarding the memory usage status, and outputs priority information to the collection control unit 101.

The collection control unit 101 includes a data collection unit 321 and a data storage unit 322. The data collection unit 321 collects measurement data d with the Pull type in order from the measurement target 110 with the highest priority, based on the information regarding the priority calculated by the priority calculation unit 102. The collection control unit 101 generates measurement data D obtained by integrating the plurality of pieces of measurement data d, for example, pieces of measurement data d1 and d2 of the same or different measurement targets 110 and stores the measurement data D in the memory (data buffer) 105.

In the example in FIG. 3, for example, the data collection unit 321 of the data collection device 1 (100) preferentially acquires the measurement data d1 of the measurement target 1 (110) with relatively high priority, of the pieces of measurement data d1 and d2 of the measurement targets 1 and 2 (110) with high priority. Next, the data collection unit 321 acquires the measurement data d2 of the measurement target 2 (110) with high priority. The collection control unit 101 generates measurement data D1 obtained by integrating the pieces of measurement data d1 and d2 collected by the data collection unit 321.

The data storage unit 322 is the memory (data buffer) 105 described above and stores the measurement data D integrated by the collection control unit 101. The data storage unit 322 stores the plurality of pieces of measurement data D in the memory and sets a flag each time when the measurement data D is stored in the memory (for example, set value “1”). The flag is set in correspondence with a data capacity that can be stored in the memory. The data storage unit 322 deletes the measurement data D1 that has been transferred to the management server 120 from the memory.

Furthermore, the data collection unit 321 of the collection control unit 101 controls a timing when the measurement data d is acquired from the measurement target 110. The data collection unit 321 determines a period (interval) every time before the measurement data d is acquired with the Pull type next each timing when the measurement data d is acquired with the Pull type at the previous time.

Here, it is assumed that, after the data collection unit 321 of the collection control unit 101 temporarily determines the interval, data transfer of one measurement target 110 become tight, and a measurement target 110 with particularly high priority occur. In this case, the data collection unit 321 executes processing for acquiring the measurement data d of the measurement target 110 having particularly high priority with the Pull type, with the highest priority. The data collection unit 321 may execute the processing for acquiring the measurement data d of the measurement target 110 with particularly high priority with the Pull type, for example, regardless of the interval.

The management server 120 includes a data processing unit 330 that investigates performances of the plurality of measurement targets (1 to n) 110, based on the measurement data D collected from the data collection device 100. The data processing unit 330 includes a data processing and shaping unit 331, a data transfer unit 332, and a database (DB) 333. In addition, the management server 120 may include a performance investigation unit 334.

The data processing and shaping unit 331 collects the measurement data D from the plurality of data collection devices 100 with the Pull type. The data processing and shaping unit 331 shapes and processes the measurement data d of the plurality of measurement targets 110 included in the collected measurement data D into a storage format of the DB 333. The data transfer unit 332 stores the measurement data shaped by the data processing and shaping unit 331 in the DB 333.

The performance investigation unit 334 executes processing for investigating the performance of each of the plurality of measurement targets 110, according to predetermined arithmetic processing on the measurement data stored in the DB 333. For example, the performance investigation unit 334 investigates a performance of the stored measurement data D, each time when the measurement data is stored in the DB 333, and stores a performance investigation result for the measurement data D in the DB 333.

Furthermore, the performance investigation unit 334 may investigate the performance of the measurement data D, each time when the data processing and shaping unit 331 of the data processing unit 330 acquires the measurement data D from the data collection device 100. In this case, the performance investigation unit 334 outputs the performance investigation result to the data transfer unit 332, and the data transfer unit 332 stores the performance investigation result as well as the measurement data D in the DB 333.

### Priority Calculation Processing Example

An example of priority calculation by the priority calculation unit 102 of the data collection device 100 will be described.

(Calculation Example 1) The priority calculation unit 102 calculates priority xₜ of the measurement target 110 at a clock time t according to the following formula (1).

$${\text{x}}_{\text{t}} = \left({\text{n}}_{\text{t}} \times \text{s}\right) / \left({\text{s}}_{\text{SDB}}\right) \qquad \text{(1)}$$

Here, an initial value of xₜ is x₀ = 0, and the priority calculation unit 102 acquires each piece of data nₜ, s, and s_{SDB} as the information p regarding the memory usage status from the measurement target 110. The reference nₜ represents the number of Pullable flags [piece] regarding the measurement data d at the clock time t, the reference s represents a size [Byte] of each piece of the measurement data d, and the reference s_{SDB} represents a size [Byte] of the memory (sampling data buffer) of the measurement target 110.

(Calculation Example 2) The priority calculation unit 102 calculates priority xₜ of the measurement target 110 at a weighted clock time t according to the following formula (2).

$${\text{x}}_{\text{t}} = \left({\text{n}}_{\text{t}} \times \text{s}\right) / \left({\text{s}}_{\text{SDB}}\right) \times \left(1 + \left({\text{n}}_{\text{t}}\right) / \left({\text{n}}_{\text{t - 1}}\right)\right) \qquad \text{(2)}$$

Here, an initial value of xₜ is x₀ = 0, and the priority calculation unit 102 increases the priority of the measurement target 110 that is not Pulled most recently and of which the Pullable measurement data d increases.

### Pull Interval Calculation Processing Example

The collection control unit 101 of the data collection device 100 determines an interval before next Pull, each time after Pull, according to calculation to be described below. For example, the collection control unit 101 calculates an interval i before next Pull according to the following formula (3).

$$\text{i} = {\text{i}}_{\text{pre}} \times \left(\left({\text{N}}_{\text{t}}\right) / \left({\text{N}}_{\text{t - 1}}\right)\right) \qquad \text{(3)}$$

Here, the reference Nₜ represents the number of pieces of measurement data d in an untransferred state at the clock time t [piece], and the reference iₚᵣₑ represents a previous interval [s]. Even in the interval period, in a case where a memory (sampling data buffer) is likely to overflow and a measurement target 110 with high priority exists, the collection control unit 101 collects measurement data d of the measurement target 110 with high priority with the Pull type.

### (Data Transfer Example Using Data Collection Device 100)

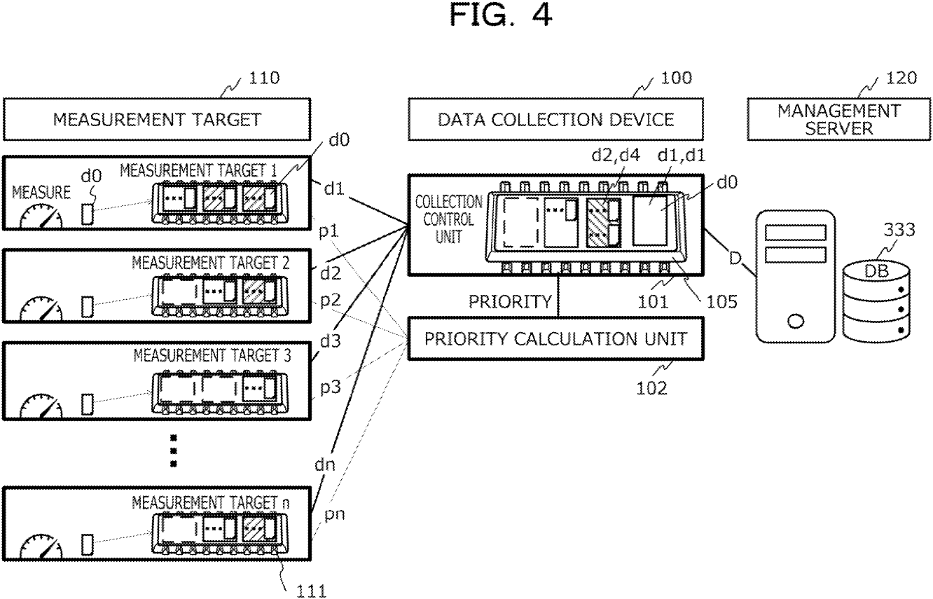

FIG. 4 is an explanatory diagram illustrating a data transfer example of measurement data by the data collection device 100. FIG. 4 illustrates the plurality of measurement targets (1 to n) 110, the single data collection device 100 that collects the measurement data d of the plurality of measurement targets 110, and the single management server 120.

The measurement target 110 includes the memory (sampling data buffer) 111, and the data collection device 100 includes the memory (data buffer) 105. In the example illustrated in FIG. 4, a memory capacity of the memory 105 of the data collection device 100 is larger than that of the memory 111 of the measurement target 110.

In the measurement target 110, the measurement unit 301 measures measurement data d0 of the measurement target 110 at each predetermined timing and stores the measurement data d0 in the memory 111 of the measurement target 110. In a case where the measurement data d0 has a fixed data length, the memory 111 can store a predetermined number of pieces of measurement data d0. For example, as illustrated in FIG. 4, it is assumed that the memory 111 of the measurement target 110 can store three pieces of measurement data d0.

Then, it is assumed that the memory 111 of the measurement target 1 (110) have stored the two pieces of the measurement data d0 (hatched in FIG. 4) and a storage destination for the remaining one be storing the measurement data d0. It is assumed that the memory 111 of the measurement target 2 (110) have stored the single piece of the measurement data d0 (hatched in FIG. 4), a storage destination for one piece be storing the measurement data d0, and a storage destination for the remaining one be empty. It is assumed that, in the memory 111 of the measurement target 3 (110), a storage destination for one piece be storing the measurement data d0, and a storage destination for the remaining two pieces be empty. It is assumed that the memory 111 of the measurement target n (110) have stored the single piece of the measurement data d0 (hatched in FIG. 4), a storage destination for one piece be storing the measurement data d0, and a storage destination for the remaining one be empty.

The data collection device 100 acquires the information p (p1 to pn) regarding the memory usage status from the plurality of measurement targets (1 to n) 110 with the Pull type by the priority calculation unit 102 and calculates the priority of each of the measurement targets (1 to n) 110.

The example in FIG. 4 will be described as assuming that the measurement target n is four. The priority calculation unit 102 sets priority of the measurement target 1 that uses the most memories 111 (the number of used memories is two) to “1” that is the highest, and sets priority of measurement targets 2 and 4 (n) of which the number of used memories 111 is one next to “2” that is the next highest priority. In a case where the used numbers are the same, the priority calculation unit 102 sets different priorities based on settings such as ascending order of identifiers (1 to n) of the measurement targets 110. In this case, the measurement target 2 has priority “2”, and the measurement target 4 (n) has priority “3”. Furthermore, the priority calculation unit 102 sets priority of the measurement target 3 that uses the least memory 111 (the number of used memories is one) to “4” that is the lowest. The priority calculation unit 102 outputs information regarding the calculated priority to the collection control unit 101.

The collection control unit 101 collects the pieces of measurement data d (d1 to dn) from the corresponding measurement targets (1 to n) 110 in order of the priority. The collection control unit 101 collects the measurement data d from the memory 111 of the measurement target 110 with “1” to which the Pullable flag is set, with the Pull type.

In the example in FIG. 4, first, the collection control unit 101 collects the two pieces of measurement data d1 from the measurement target 1 with the priority “1”. Next, the collection control unit 101 collects the one piece of measurement data d2 from the measurement target 2 with the priority “3”. Next, the collection control unit 101 collects the one piece of the measurement data d4 (n) from the measurement target 4 (n) with the priority “2”. Then, the measurement data d3 of the measurement target 3 with the priority “4” has no Pullable flag, for example, is in a state where the memory 111 of the measurement target 3 has a free space. Therefore, at this point of time, the collection control unit 101 does not collect the measurement data d3 of the measurement target 3.

The collection control unit 101 stores the pieces of measurement data d (d1 to d4) collected from the plurality of measurement targets (1 to n) 110 in the memory (data buffer) 105. The memory 105 can store a predetermined number of pieces of measurement data d1 to d4. In the example illustrated in FIG. 4, it is assumed that the memory 105 of the data collection device 100 can store eight pieces of measurement data d. Here, the collection control unit 101 generates measurement data D obtained by integrating a predetermined number of pieces of measurement data d. For example, in the example in FIG. 4, the collection control unit 101 generates measurement data D obtained by integrating every two pieces of measurement data d. In this case, the memory 105 can store the measurement data D obtained by integrating four pieces of measurement data d into every two pieces of measurement data d.

For example, the collection control unit 101 generates measurement data D that corresponds to the priority and is obtained by integrating two pieces of measurement data d1 input with the priority “1”. Next, the collection control unit 101 generates measurement data D obtained by integrating one piece of measurement data d2 and measurement data d4 (n) collected in order of the priority “2” and “3”.

Thereafter, the management server 120 collects the measurement data D with “1” to which the Pullable flag is set, with the Pull type. At this time, for example, the collection control unit 101 transfers the measurement data D to the management server 120 in order of storage of the measurement data D into the memory 105.

In the above description, for simplification, it is assumed that the memory 111 of the measurement target 110 can store a predetermined number of pieces (three) of measurement data d0. Actually, as illustrated in FIG. 4, in a case where the memory 111 is divided into three, each divided region stores the plurality of pieces of measurement data d0. For example, the measurement target 110 groups the plurality of pieces of measurement data d0 measured a plurality of times into groups of a predetermined number of pieces and stores the grouped measurement data d0 in the memory 111. Each piece of the measurement data d1 to dn includes the plurality of grouped pieces of measurement data d0.

Furthermore, the measurement data d0 includes attribute information and a measurement value. The attribute information is, for example, an identifier (ID) that can identify the measurement target 110. After extracting the measurement data d1 to dn from the measurement data D acquired from the data collection device 100, the management server 120 can specify the corresponding measurement targets (1 to n) 110 based on an identifier of the measurement data d0 included in the measurement data d1 to dn. Then, the management server 120 performs predetermined four arithmetic operations on measurement values of the plurality of pieces of measurement data d0 in a predetermined period so as to execute the processing for investigating the performances of the specified measurement targets (1 to n) 110. The management server 120 can calculate a performance investigation result for each of the measurement targets (1 to n) 110 using the identifiers, and can output the performance investigation result to outside and store the performance investigation result in the DB (333).

### Processing Example of Measurement Target

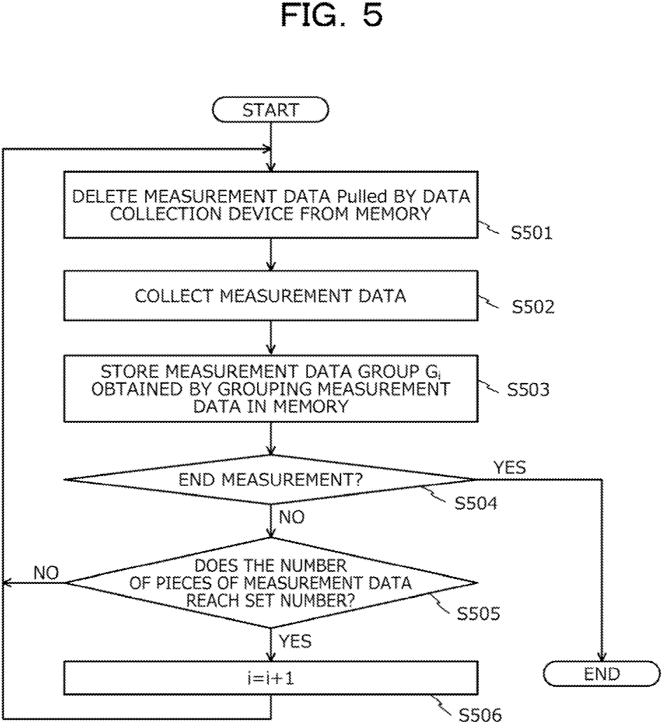

FIG. 5 is a flowchart illustrating an example of a processing procedure of the measurement target 110. The processing in FIG. 5 is executed by the control unit (CPU 201) of the measurement target 110. In the processing in FIG. 5, an example is illustrated in which the measurement target 110 groups the plurality of pieces of measurement data d0 and stores the measurement data d0 in the memory (sampling data buffer) 111.

First, the measurement target 110 deletes the measurement data d0 Pulled by the data collection device 100 from the memory (sampling data buffer) 111 (step S501).

Next, the measurement target 110 collects a predetermined piece of measurement data d0 (step S502). Next, the measurement target 110 stores a measurement data group Gᵢ obtained by grouping each of the plurality of pieces of measurement data d0 in the memory (sampling data buffer) 111 (step S503).

Next, the measurement target 110 determines whether or not the measurement has ended (step S504). Here, if the measurement has not ended (step S504: No), the measurement target 110 proceeds to processing in step S505. On the other hand, if the measurement has ended (step S504: Yes), the measurement target 110 ends the processing illustrated in FIG. 5.

In step S505, the measurement target 110 determines whether or not the number of pieces of measurement data reaches a consolidated number (step S505). The consolidated number is a number with which the number of measurement data groups Gᵢ stored in the memory (sampling data buffer) 111 is set to a predetermined number (Pullable flag “1”). The measurement target 110 performs data transfer on the measurement data d described above using the consolidated number as units by Pull from the data collection device 100.

In step S505, if the number of pieces of measurement data reaches the consolidated number (step S505: Yes), the measurement target 110 increments a coefficient i of the consolidated number (step S506) and returns to the processing in step S501. On the other hand, if the number of pieces of measurement data does not reach the consolidated number (step S505: No), the measurement target 110 returns to the processing in step S501.

### Processing Example of Priority Calculation Unit

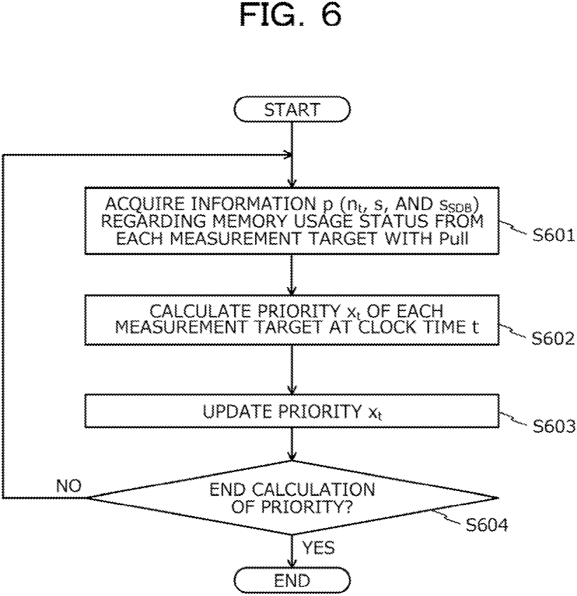

FIG. 6 is a flowchart illustrating an example of a processing procedure of the priority calculation unit 102. The processing illustrated in FIG. 6 is executed by a control unit (CPU 201) of the data collection device 100.

First, the priority calculation unit 102 acquires the information p (nₜ, s, and s_{SDB}) regarding the memory usage status from each measurement target 110 with Pull (step S601). Next, the priority calculation unit 102 calculates priority xₜ of each measurement target 110 at the clock time t (step S602). Here, for example, the priority calculation unit 102 calculates the priority xₜ based on the calculation example 1 (formula (1) described above) described above or the calculation example 2 (formula (2) described above).

Next, the priority calculation unit 102 updates the holding priority xₜ (step S603). Next, the priority calculation unit 102 determines whether or not the calculation of the priority ends (step S604). Here, if the calculation of the priority does not end (step S604: No), the priority calculation unit 102 returns to the processing in step S601. On the other hand, if the calculation of the priority ends (step S604: Yes), the priority calculation unit 102 ends the processing illustrated in FIG. 6.

### Processing Example of Collection Control Unit

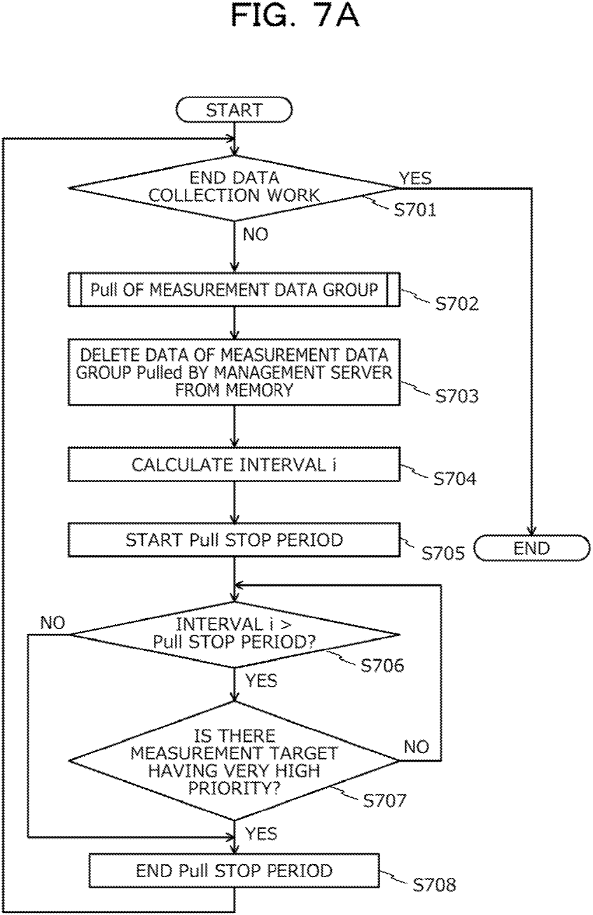

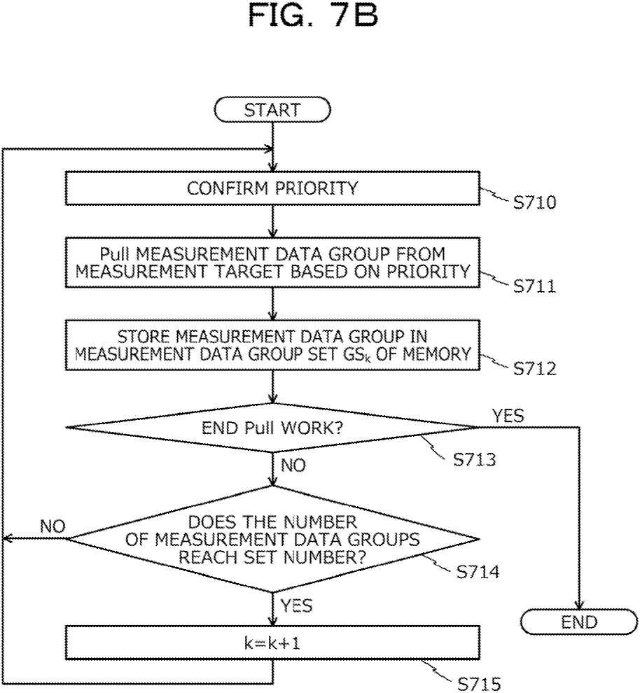

FIGS. 7A to 7B are flowcharts illustrating an example of a processing procedure of the collection control unit 101. Processing illustrated in FIGS. 7A and 7B is executed by the control unit (CPU 201) of the data collection device 100.

As illustrated in FIG. 7A, the collection control unit 101 collects the measurement data d with the Pull type for the plurality of measurement targets 110. The collection control unit 101 may simultaneously collect the measurement data d with the Pull type for all the plurality of measurement targets 110 or may collect the measurement data d through the Pull-type data transfer at different timings for each of the plurality of measurement targets 110.

First, the collection control unit 101 determines whether or not to end a data collection work (step S701). Here, in a case where the data collection work does not end and is started or continued (step S701: No), the collection control unit 101 proceeds to processing in step S702. On the other hand, in a case where the data collection work ends (step S701: Yes), the collection control unit 101 ends the processing illustrated in FIG. 7A.

In step S702, the collection control unit 101 acquires the measurement data group Gᵢ from each measurement target 110 with Pull (step S702). Details of the processing in step S702 will be described with reference to FIG. 7B.

Next, the collection control unit 101 deletes the measurement data of the measurement data group Gᵢ Pulled by the management server 120 from the memory (buffer memory) 105 (step S703). Next, the collection control unit 101 calculates an interval i of Pull for collecting the measurement data d from the measurement target 110, for example, based on the formula (3) described above (step S704).

Next, the collection control unit 101 collects the measurement data d with the Pull type from the measurement target 110 at intervals of the interval i (processing in steps S705 to S708). First, the collection control unit 101 starts a Pull stop period (step S705) and determines whether or not interval i > Pull stop period (step S706). Here, if interval i > Pull stop period (step S706: Yes), the collection control unit 101 proceeds to processing in step S707. On the other hand, if interval i > Pull stop period is not satisfied (step S706: N), the collection control unit 101 proceeds to processing in step S708.

In step S707, the collection control unit 101 determines whether or not there is a measurement target 110 having very high priority in the Pull stop period (step S707). Here, if there is a measurement target 110 having very high priority in the Pull stop period (step S707: Yes), the collection control unit 101 proceeds to processing in step S708. On the other hand, if there is no measurement target 110 having very high priority in the Pull stop period (step S707: No), the collection control unit 101 returns to the processing in step S706.

In step S708, the collection control unit 101 ends the Pull stop period (step S708), and collects the measurement data d from the measurement target 110 with the Pull type and returns to the processing in step S701.

FIG. 7B illustrates details of the processing illustrated in step S702 in FIG. 7A (Pull processing from measurement target 110).

The collection control unit 101 confirms the priority calculated by the priority calculation unit 102 (step S710). Next, the collection control unit 101 collects the measurement data group Gᵢ from the memory (sampling data buffer) 111 of the measurement target 110, to which the Pullable flag “1” is set, from among the measurement targets 110 based on the priority, in consolidated number units with Pull (step S711).

Next, the collection control unit 101 stores the collected measurement data group Gᵢ in a measurement data group set GSₖ of the memory (buffer memory) 105 (step S712). The measurement data group set GSₖ is a group in consolidated number units on the memory (buffer memory) 105 and corresponds to the grouped measurement data D described above.

Next, the collection control unit 101 determines whether or not a Pull work has ended (step S713). Here, if the Pull work has not ended (step S713: No), the collection control unit 101 proceeds to processing in step S714. On the other hand, if the Pull work has ended (step S713: Yes), the collection control unit 101 ends the processing illustrated in FIG. 7B.

In step S714, the collection control unit 101 determines whether or not the number of collected measurement data groups Gᵢ reaches the consolidated number of the measurement data group set GSₖ (step S714). Here, if the number of measurement data groups Gᵢ does not reach the consolidated number of the measurement data group set GSₖ (step S714: No), the collection control unit 101 returns to the processing in step S710. On the other hand, if the number of measurement data groups Gᵢ reaches the consolidated number of the measurement data group set GSₖ (step S714: Yes), the collection control unit 101 increments a coefficient k of the consolidated number and returns to the processing in step S710.

### Processing Example of Management Server

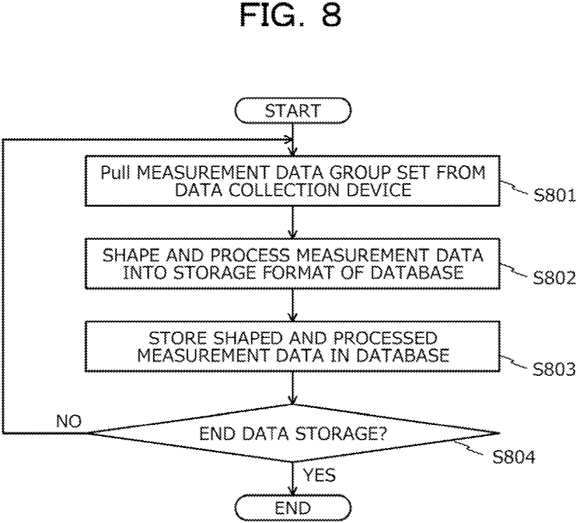

FIG. 8 is a flowchart illustrating an example of a processing procedure of the management server 120. The processing illustrated in FIG. 8 is executed by the control unit (CPU 201) of the management server 120.

First, the management server 120 collects the measurement data group set GSₖ (grouped measurement data D) from the data collection device 100 with the Pull type (step S801). Next, the management server 120 shapes and processes the measurement data D (measurement data d extracted from measurement data D) into the storage format of the DB 333 (step S802). Next, the management server 120 stores the shaped and processed measurement data d in the DB 333 (step S803) and determines whether or not the data storage into the DB 333 has ended (step S804). Here, if the data storage has not ended (step S804: No), the management server 120 returns to the processing in step S801. On the other hand, if the data storage has ended (step S804: Yes), the management server 120 ends the above processing.

Although not illustrated in FIG. 8, for example, the management server 120 can read the measurement data d from the DB 333 after the processing in FIG. 8 and perform necessary performance investigation. Furthermore, the management server 120 may store the performance investigation result in association with the measurement data d in the DB 333 again.

### Specific Example of Pull Control Based on Priority Calculation

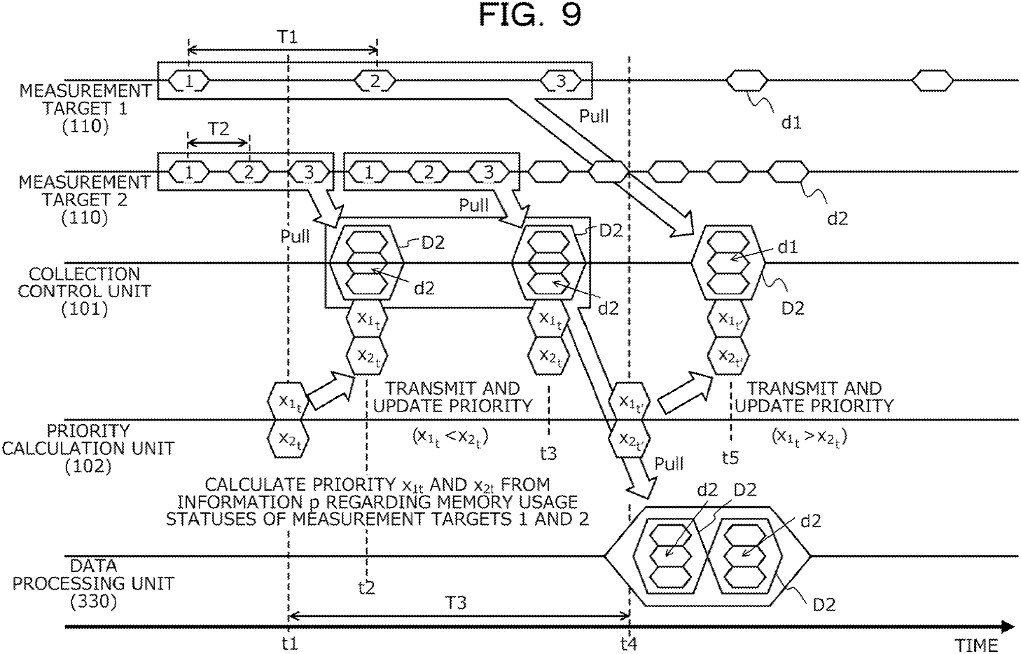

FIG. 9 is a timing chart of a specific example of Pull control based on priority calculation performed by the data collection device 100. The vertical axis indicates the measurement targets 1 and 2 (110), the collection control unit 101, the priority calculation unit 102, and the management server 120 (data processing unit 330) of the data collection device 100, and the horizontal axis indicates time. The memory (sampling data buffer) 111 of the measurement targets 1 and 2 (110) can store up to three pieces of measurement data d, and it is assumed that the memory (sampling data buffer) 111 set the Pullable flag “1” when storing the three pieces of measurement data d.

It is assumed that the measurement target 1 (110) measure the measurement data d1 at a measurement cycle T1 and the measurement target 2 (110) measure the measurement data d2 at a measurement cycle T2 (T1 > T2).

The priority calculation unit 102 of the data collection device 100 collects the information p regarding the memory usage status from the measurement targets 1 and 2 (110) with the Pull type at a predetermined interval T3. At a time t1, the priority calculation unit 102 calculates priority x₁ₜ of the measurement target 1 and priority x₂ₜ of the measurement target 2. Then, in the example in FIG. 9, the priority calculation unit 102 determines that priority x₁ₜ < x₂ₜ. At this time t1, the measurement target 2 is in a state the three pieces of measurement data d is stored in the memory (sampling data buffer) 111 prior to the measurement target 1. Then, the priority calculation unit 102 sets the priority of the measurement target 2 to “1” and the priority of the measurement target 1 to “2” and transmits the priority to the collection control unit 101 and updates the priority.

The collection control unit 101 preferentially collects the measurement data D2 of the measurement target 2 with higher priority “1” with Pull at a time t2, according to the priority transmitted from the priority calculation unit 102. In the example in FIG. 9, the measurement data D2 includes three pieces of measurement data d2. Furthermore, the collection control unit 101 preferentially collects the measurement data D2 of the measurement target 2 with higher priority “1” with Pull at a time t4, based on the result of the priority updated at the time t1, at a time t3 in a period of the interval T3.

In the example in FIG. 9, the memory (data buffer) 105 of the data collection device 100 can store up to two grouped pieces of measurement data D, and it is assumed that the Pullable flag “1” be set when the two pieces of measurement data D is stored. In this case, at the time t4, the management server 120 (data processing unit 330) collects the measurement data D2 for two times from the memory (data buffer) 105 of the data collection device 100 with the Pull type.

Furthermore, the priority calculation unit 102 calculates the priority x₁ₜ of the measurement target 1 and the priority x₂ₜ of the measurement target 2 at the time t4 again. At the time t4, the priority calculation unit 102 determines that the priority x₁ₜ > x₂ₜ. At this time t4, the measurement target 1 is in a state where the three pieces of measurement data d is stored in the memory (sampling data buffer) 111 prior to the measurement target 2. Then, the priority calculation unit 102 sets the priority of the measurement target 1 to “1” and the priority of the measurement target 2 to “2” and transmits the priority to the collection control unit 101 and updates the priority.

Then, the collection control unit 101 preferentially collects the measurement data d1 of the measurement target 1 with higher priority “1” with Pull at a time t5, based on the result of the priority updated at the time t4.

### Related Art

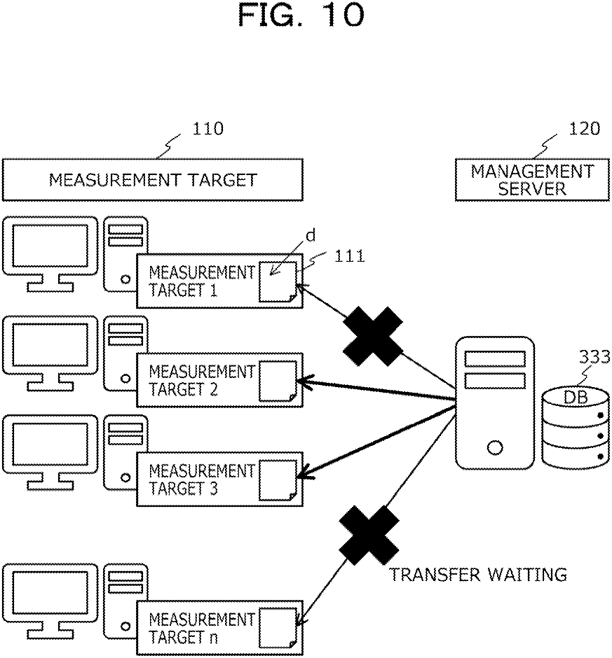

Related art of measurement data transfer will be described with reference to FIGS. 10 to 12B and is compared with the embodiment. In the description of the related art, the component similar to that in the embodiment is denoted with the same reference. FIG. 10 is an explanatory diagram of a transfer state of measurement data according to the related art. In FIG. 10, the measurement target 110 is a computer device (machine) such as a PC, or a CPU, a memory, or the like in the machine.

As illustrated in FIG. 10, in a case where the number n of the measurement targets 110 is larger with respect to a single management server 120 (1: n), transfer waiting of measurement data of one measurement target 110 may occur between the measurement target 110 and the management server 120. In the example in FIG. 10, transfer waiting (x mark) occurs between the measurement targets 1 and n (110) and the management server 120.

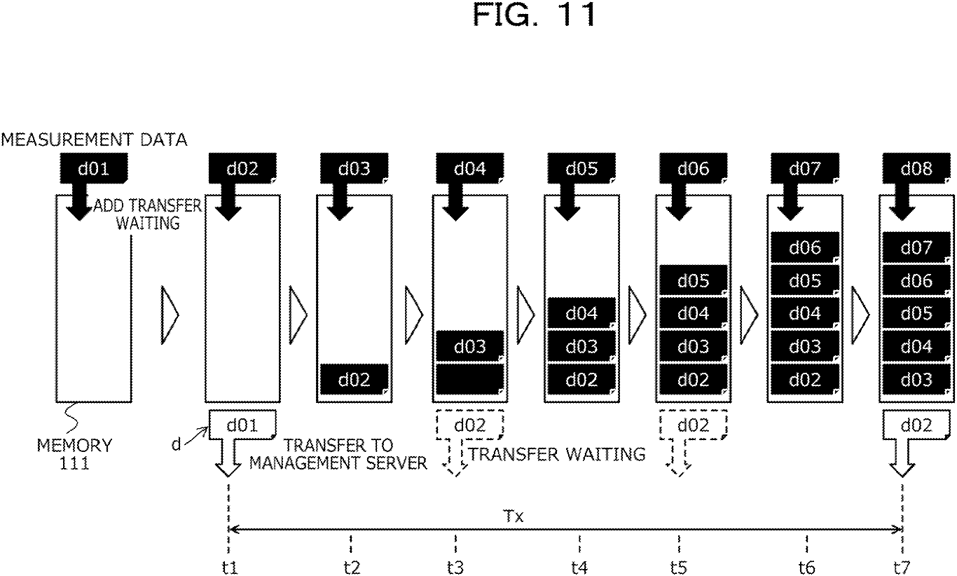

FIG. 11 is an explanatory diagram of a memory usage rate of the measurement target according to the related art. When transfer waiting occurs in the measurement target 110, a memory usage rate of the memory (sampling data buffer) 111 on the measurement target 110 increases. In the example illustrated in FIG. 11, the measurement data d0 (d01 to d0n) is stored in the memory 111 at a fixed cycle. The measurement target 110 performs transfer, for example, in units of the measurement data d stored in the memory 111 at each fixed interval Tx to the management server 120.

In this case, after transferring the measurement data d (d01) at the time t1, the measurement target 110 transfers the measurement data d (d02) next at a time t7. However, at the time t7, only the measurement data d02, of the measurement data d (d02 to d08) in the interval Tx, is transferred, and the measurement data d03 to d08 is held on the memory 111. In this way, the memory 111 continues to store the measurement data d0 in the memory 111 when the memory 111 is in a transfer waiting state, the untransferred measurement data d (d03 to d08) increases on the memory 111.

By the way, it is considered to increase the number of pieces of measurement data d to be transferred at the times t1 and t7. However, if the measurement frequency of the measurement data d0 stored in the memory 111 is higher than the transfer frequency of the measurement data d transferred from the memory 111 to the management server 120, similarly, the untransferred measurement data d increases in the memory 111.

The measurement targets 1 and n (110) in which transfer waiting occurs illustrated in FIG. 10 restart measurement while holding the measurement data d, of which communication is attempted and which waits or which has been measured and has not been transferred, in the memory 111. However, in a case where the measurement frequency is higher than the transfer frequency of the data in the measurement target 110 in which transfer waiting occurs, the usage rate of the memory 111 increases, and the memory capacity is consumed.

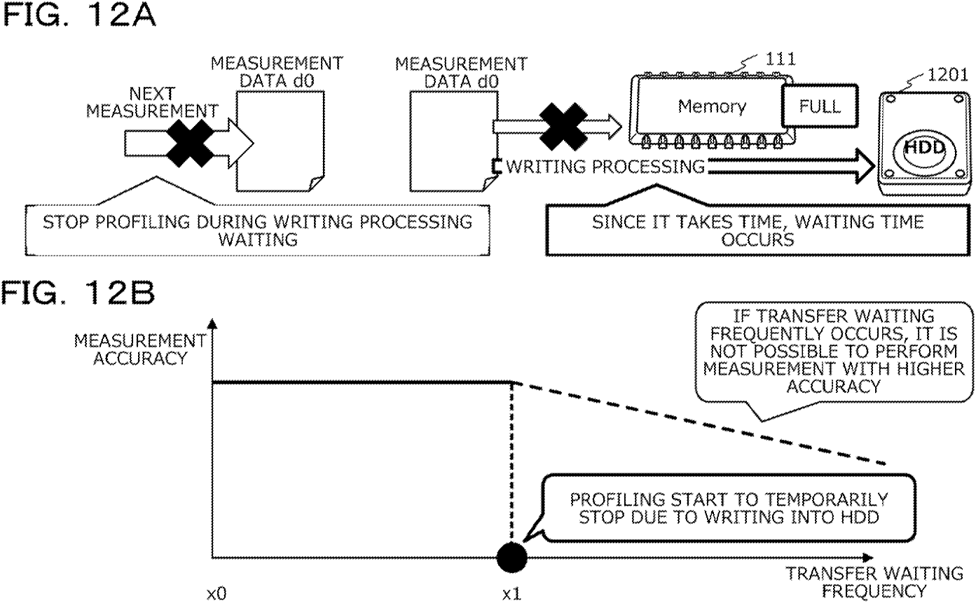

FIGS. 12A and 12B are explanatory diagrams illustrating a relationship between a frequency of transfer waiting and performance investigation accuracy according to the related art. As illustrated in FIG. 12A, in a case where there is no more free space of the memory 111, the measurement target 110 executes processing for writing the measurement data d0 into an auxiliary storage device (for example, hard disk drive (HDD) 1201). In this case, in the measurement target 110, since the processing for writing into the HDD 1201 takes time, waiting time for the writing processing into the memory 111 is generated, and measurement (profiling) of next (new) measurement data dx of this writing processing waiting stops.

FIG. 12B is a table for explaining measurement (performance investigation) accuracy. The horizontal axis in FIG. 12B indicates a transfer waiting frequency, and the vertical axis indicates measurement (performance investigation) accuracy. Since the measurement data d0 can be stored in the memory 111 when the transfer waiting frequency is between x0 to x1, the measurement target 110 obtains predetermined measurement accuracy. However, when the transfer waiting frequency exceeds x1, there is no free space in the memory 111 of the measurement target 110, and the profiling starts to temporarily stop due to writing into the HDD 1201. Then, as the transfer waiting frequency becomes equal to or higher than x1 and transfer waiting frequently occurs, the measurement accuracy decreases, and it is not possible to perform measurement with higher accuracy.

Whereas, in the embodiment, by arranging the data collection device 100 between the management server 120, in the 1: n configuration in which the plurality of measurement targets 110 is connected to the management server 120, a transfer waiting problem caused in the related art described above is solved. As described above, the data collection device 100 according to the embodiment calculates the priority according to the tightness degree (memory usage rate or the like) of the memory 111 of the plurality of measurement targets 110 and preferentially collects the measurement data d of the measurement target 110 with high priority.

As a result, even in the system including the plurality of measurement targets 110 with respect to the management server 120 (1: n), the data collection device 100 can prevent occurrence of transfer waiting without consuming the memory 111 of the measurement target 110 and can achieve measurement (performance investigation) with high accuracy.

Furthermore, the data collection device 100 collects the measurement data d from the measurement target 110 with the Pull type. As a result, the measurement target 110 does not need to voluntarily control the transfer of the measurement data d and can reduce a processing load.

Furthermore, the measurement target 110 and the data collection device 100 respectively store the plurality of pieces of grouped measurement data d in the memories 111 and 105 in group units. As a result, in the embodiment, addition processing and deletion processing of the measurement data d do not conflict, a timing when measurement is not possible is less likely to occur, and deterioration in the measurement accuracy can be prevented.

As described above, according to the data collection device 100, it is possible to acquire information regarding a usage status of a first memory for data transfer included in the measurement target from each of the plurality of measurement targets. According to the data collection device 100, it is possible to calculate the priority of the data transfer of each of the plurality of measurement targets, based on the acquired information regarding the usage status of the first memory. According to the data collection device 100, it is possible to collect measurement data from the first memory of any one of the plurality of measurement targets, based on the calculated priority. According to the data collection device 100, it is possible to store the collected measurement data in a second memory that stores measurement data that is output to a data processing unit for processing the measurement data of each of the plurality of measurement targets. As a result, the data collection device 100 can prevent that the first memory that stores the measurement data in one measurement target is consumed and memory overflow occurs, even if the number of measurement targets becomes plural and enormous. Furthermore, the data collection device 100 can efficiently collect all the pieces of the measurement data of the plurality of measurement targets and output the measurement data to the data processing unit.

According to the data collection device 100, the storing processing can store the collected measurement data in the second memory for each predetermined set number. According to the data collection device 100, it is possible to output the measurement data for each set number from the second memory through the Pull-type data transfer from the data processing unit. As a result, the data collection device 100 can efficiently collect the measurement data for each set number from the measurement target. Furthermore, even if addition and deletion of the measurement data in the second memory conflict, the data collection device 100 can smoothly execute these processing.

According to the data collection device 100, the calculating processing can calculate higher priority for the plurality of measurement targets of which a remaining amount of the acquired first memory is smaller. According to the data collection device 100, the collecting processing can preferentially process the measurement target with higher priority from among the plurality of measurement targets. As a result, the data collection device 100 can collect the measurement data in order from the measurement target of which the remaining amount of the first memory is smaller, for example, according to the calculated priority. The data collection device 100 can prevent that the measurement target of which the remaining amount of the first memory is small consumes the first memory and the profiling of the measurement data temporarily stops, and can prevent deterioration in the accuracy of the performance investigation of the measurement target caused by missing measurement data.

According to the data collection device 100, the acquiring processing can acquire the information regarding the usage status of the first memory from the plurality of measurement targets through the Pull-type data transfer. According to the data collection device 100, the collecting processing can collect the measurement data from the first memory of the plurality of measurement targets through the Pull-type data transfer. As a result, the data collection device 100 can acquire the information regarding the usage status of the first memory and collect the measurement data without applying a processing load of data transfer control to each measurement target.

According to the data collection device 100, the collecting processing can determine the interval of the Pull-type data transfer for each of the plurality of measurement targets according to the usage status of the first memory of each of the plurality of measurement targets each time when the Pull-type data transfer is performed. As a result, the data collection device 100 can prevent, for example, the overflow of the first memory in the measurement target of which the remaining amount of the first memory is small among the plurality of measurement targets and efficiently collect the measurement data.

According to the data collection device 100, the collecting processing can collect a group of the plurality of pieces of measurement data measured by the measurement target. As a result, the data collection device 100 can prevent occurrence of a timing when measurement data cannot be measured or the like in advance even if addition and deletion of the measurement data in the first memory of the measurement target conflict.

According to the data collection device 100, it is further possible to delete the measurement data output from the second memory through the Pull-type data transfer by the data processing unit. As a result, the data collection device 100 can efficiently use the second memory as immediately increasing a free space of the second memory by deleting the measurement data that has been transferred and output to the data processing unit, and can constantly and stably store the measurement data collected from the plurality of measurement targets with no memory overflow.

According to the data collection device 100, the Pull-type data transfer timing in the acquiring processing and the Pull-type data transfer timing in the collecting processing can be asynchronous with the Pull-type data transfer timing by the data processing unit. As a result, the data collection device 100 can acquire the information regarding the usage status of the first memory of the measurement target and collect the measurement data of the measurement target at an appropriate timing without applying a processing load of data transfer control to each measurement target. Furthermore, the data collection device 100 can output the measurement data stored in the second memory to the data processing unit through the Pull-type data transfer from the data processing unit, without the processing load of the data transfer control.

Note that the management method described in the present embodiment may be implemented by executing a prepared program on a computer such as a PC or a workstation. The management program described in the present embodiment is executed by being recorded on a computer-readable recording medium and being read from the recording medium by the computer. The recording medium is a hard disk, a flexible disk, a compact disc (CD)-ROM, a magneto optical disc (MO), a digital versatile disc (DVD), or the like. Furthermore, the management program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a management program for causing a computer to execute processing, comprising:
acquiring information regarding a usage status of a first memory for data transfer included in a measurement target from each of a plurality of the measurement targets;
calculating priority of data transfer of each of the plurality of measurement targets, based on the acquired information regarding the usage status of the first memory;
collecting measurement data from the first memory of any one of the plurality of measurement targets, based on the calculated priority; and
storing the collected measurement data in a second memory that stores measurement data output to a data processing unit that processes the measurement data of each of the plurality of measurement targets.

2. The non-transitory computer-readable recording medium according to claim 1, wherein
the storing processing
stores the collected measurement data in the second memory for each predetermined set number, and
the non-transitory computer-readable recording medium storing the management program for causing the computer to execute processing comprising:
outputting the measurement data for each set number from the second memory through Pull-type data transfer from the data processing unit.

3. The non-transitory computer-readable recording medium according to claim 1, wherein
the calculating processing
calculates higher priority for the plurality of measurement targets of which a remaining amount of the acquired first memory is smaller, and
the collecting processing
preferentially processes a measurement target with higher priority among the plurality of measurement targets.

4. The non-transitory computer-readable recording medium according to claim 1, wherein
the acquiring processing
acquires the information regarding the usage status of the first memory from the plurality of measurement targets through Pull-type data transfer, and
the collecting processing
collects the measurement data from the first memory of the plurality of measurement targets through Pull-type data transfer.

5. The non-transitory computer-readable recording medium according to claim 4, wherein
the collecting processing
determines an interval of Pull-type data transfer for each of the plurality of measurement targets according to the usage status of the first memory of each of the plurality of measurement targets each time when the Pull-type data transfer is performed.

6. The non-transitory computer-readable recording medium according to claim 4, wherein
the collecting processing
collects a group of a plurality of pieces of measurement data measured by the measurement target.

7. The non-transitory computer-readable recording medium according to claim 4, for causing the computer to execute processing, further comprising:
deleting the measurement data output from the second memory through Pull-type data transfer by the data processing unit.

8. The non-transitory computer-readable recording medium according to claim 7, wherein a timing of Pull-type data transfer in the acquiring processing, a timing of Pull-type data transfer in the collecting processing, and a timing of Pull-type data transfer by the data processing unit are asynchronous with each other.

9. A management method comprising:
acquiring information regarding a usage status of a first memory for data transfer included in a measurement target from each of a plurality of the measurement targets;
calculating priority of data transfer of each of the plurality of measurement targets, based on the acquired information regarding the usage status of the first memory;
collecting measurement data from the first memory of any one of the plurality of measurement targets, based on the calculated priority; and
storing the collected measurement data in a second memory that stores measurement data output to a data processing unit that processes the measurement data of each of the plurality of measurement targets.

10. A data collection device comprising:
a memory; and
a processor coupled to the memory and configured to:
acquiring information regarding a usage status of a first memory area for data transfer included in a measurement target from each of a plurality of the measurement targets;
calculating priority of data transfer of each of the plurality of measurement targets, based on the acquired information regarding the usage status of the first memory area;
collecting measurement data from the first memory area of any one of the plurality of measurement targets, based on the calculated priority; and
storing the collected measurement data in a second memory area that stores measurement data output to a data processing unit that processes the measurement data of each of the plurality of measurement targets.

11. The data collection device according to claim 10, wherein
the measurement data stored in the second memory area is output to an external device through Pull-type data transfer.
